(19) United States
(12) Patent Application Publication
(10) Pub. No.: US 2015/0060421 A1
(43) Pub. Date: Mar. 5, 2015

(54) LASER ANNEALING APPARATUS AND LASER ANNEALING METHOD

(71) Applicant: HITACHI INFORMATION & TELECOMMUNICATION ENGINEERING, LTD., Yokohama-shi (JP)

(72) Inventors: Yoshiharu TAMI, Ashigarakami-gun (JP); Kazuhiro SOGA, Ashigarakami-gun (JP); Yoshiaki OGINO, Ashigarakami-gun (JP)

(73) Assignee: HITACHI INFORMATION & TELECOMMUNICATION ENGINEERING, LTD., Yokohama-shi (JP)

(21) Appl. No.: 14/284,989

(22) Filed: May 22, 2014

(30) Foreign Application Priority Data
Aug. 30, 2013 (JP) 2013-180164

(51) Int. Cl. B23K 26/00

(52) U.S. Cl. CPC B23K 26/0066
USPC 219/121.77

(57) ABSTRACT

Metal is locally heated to a predetermined temperature within a predetermined time.

A laser annealing apparatus forms a line beam at a focusing position in a heatable area on a workpiece by an optical system, which has a long and narrow shape having a width of 0.5 μm all to 20 μm in the short direction and a long width of 6 μm to 200 μm in the length direction and has a depth of focus in the range of 2 μm to 4 μm, by using a semiconductor laser element that generates laser light, while moving a movable stage on which the workpiece has been mounted in an X direction and a Y direction; and selectively performs a heating step of performing laser annealing while controlling focusing and second laser power that has an output lower than the output of first laser power in the unheatable area on the workpiece.

### BACKGROUND OF THE INVENTION

1. Field of the Invention

The present invention relates to a laser annealing apparatus and a laser annealing method that can locally heat metal to a predetermined temperature within a predetermined time.

2. Description of the Related Art

In general, annealing treatment is heat treatment that to remove internal strain caused by work hardening and to improve ductility by softening structure. An annealing technique using an electric furnace in which a workpiece is put for hours so as to be heated to a high temperature as a whole, and a laser annealing technique that heats an arbitrary portion of a workpiece to a high temperature by the irradiation of solid-state laser (YAG laser or the like) having a relatively high output or gas laser (excimer laser or the like) are known as metal annealing in the related art.

Meanwhile, examples of a document in which an annealing technique for metal is disclosed include Japanese Patent Application Laid-Open (JP-A) Nos. 10-200068 and 2011-66428. JP-A No. 10-200068 discloses a technique for manufacturing a semiconductor that includes forming copper wires having excellent heat resistance below a stacked capacitor formed above word lines and bit lines, disposing a capacitor at the uppermost portion, and performing annealing by an electric furnace of 450° C. or more or the like. JP-A No. 2011-66428 discloses a laser annealing technique that includes a means for splitting the spot of one of a plurality of YAG laser beams into two pieces and replacing the split laser beams so that each cutting plane is located on the outside and a means for superposing the plurality of laser beams on one line, thereby performing uniform annealing on a body to be irradiated.

Since the annealing technique using the electric furnace disclosed in JP-A No. 10-200068 uses the electric furnace, a portion other than an object to be heated is also heated. Accordingly, when, for example, a semiconductor circuit is used as the workpiece, there is a problem in that a circuit element, a lower layer of a multilayer film or the like, which is weak to the heat of other portions except for an object to be annealed, is heated due to a temperature rise of the entire workpiece. Further, since an apparatus using a YAG laser or an excimer laser requires a large focus lens, it is difficult to add an auto-focus mechanism due to the structure of the apparatus. For this reason, a depth of focus (the focusing range in a vertical direction) is increased by using a stationary lens having a low numerical aperture (NA) to avoid a focus deviation corresponding to the displacement (vibration or the bending or inclination of a workpiece) of a workpiece in a height direction.

However, if a lens having a low NA is used, a range affected by heat, which is applied in a planar (horizontal) direction and a depth (vertical) direction of a workpiece, is increased. For this reason, there is a problem in that it is difficult to perform the local (in a thickness direction, a circumferential direction, or the like) annealing of a semiconductor circuit element in which circuit elements unsuitable for heating and circuit elements to be heated are mixed.

### SUMMARY OF THE INVENTION

An object of the invention is to solve the above-mentioned problems in the related art, and is to provide a laser annealing apparatus and a laser annealing method that can locally heat metal to a predetermined temperature within a predetermined time.

In order to achieve the object, according to an aspect of the invention, there is provided a laser annealing apparatus that irradiates metal of a workpiece, on which heatable areas including metal disposed at arbitrary portions thereof and unheatable areas unsuitable for heating are disposed, with a long and narrow shape line beam to heat the metal and changes the grain size or bonding state of the metal. The laser annealing apparatus includes: a semiconductor laser element that generates laser light having a wavelength with high absorptance to metal; a lens that polarizes the laser light, which is generated from the semiconductor laser element, to collimated light; a beam splitter through which laser light emitted from the lens passes and which polarizes reflected light at an angle of 90° and emits the polarized light; an objective lens that has a high numerical aperture, and irradiates the workpiece with a line-shaped line beam that is formed by the concentration of the laser light emitted from the beam splitter; a movable stage on which the workpiece is mounted and which moves the workpiece in an X direction and a Y direction on a plane at an arbitrary speed; a laser controller that controls the laser emission of the semiconductor laser element; a focus detector that detects light reflected from the workpiece by the beam splitter and converts the reflected light into an electrical signal; an auto-focus controller that controls the focusing of the line beam on the basis of the electrical signal converted by the focus detector; a stage controller that controls the movement of the movable stage in the X direction and the Y direction; and a control means for controlling the laser controller, the auto-focus controller, and the stage controller. While the stage controller moves the movable stage in the X direction and the Y direction, the laser controller forms a line beam at a focusing position on the workpiece in the heatable area on the workpiece by an optical system, which has a long and narrow shape having a width of 0.5 μm to 20 μm in the short direction and a width of 6 μm to 200 μm in the length direction and has a depth of focus in the range of 2 μm to 4 μm. A heating step of performing laser annealing while controlling the focusing by the auto-focus controller and second laser power that has an output lower than the output of the first laser power in the unheatable area on the workpiece are selectively performed by the laser controller.

A laser annealing apparatus and a laser annealing method according to the invention form a line beam at a focusing position on a workpiece in a heatable area on the workpiece by an optical system, which has a long and narrow shape having a width of 0.5 μm to 20 μm in the short direction and a width of 6 μm to 200 μm in the length direction and has a depth of focus in the range of 2 μm to 4 μm, by using a semiconductor laser element that generates laser light having a wavelength with high absorptance to metal, while moving a movable stage on which the workpiece has been mounted in an X direction and a Y direction; and selectively perform a heating step of performing laser annealing while controlling focusing and second laser power that has an output lower than the output of the first laser power in the unheatable area on the workpiece. Accordingly, a semiconductor circuit element in which circuit elements unsuitable for heating and circuit elements to be heated are mixed can also be heated locally (in a thickness direction, a circumferential direction, or the like).

### BRIEF DESCRIPTION OF THE DRAWINGS

FIG. 1 is a diagram illustrating the principle structure of a laser annealing apparatus according to an embodiment of the invention;

FIG. 2 is a diagram illustrating the line beam scanning of the laser annealing apparatus according to this embodiment;

FIG. 3 is a diagram illustrating a movable stage of this embodiment;

FIGS. 4A and 4B are diagrams illustrating an annealing operation of this embodiment;

FIGS. 5A and 5B are diagrams illustrating a workpiece that is an object to be subjected to laser annealing of this embodiment; and

FIG. 6 is a diagram illustrating a laser annealing operation of this embodiment that is to be performed on a workpiece.

### DETAILED DESCRIPTION OF THE PREFERRED EMBODIMENTS

An embodiment of a laser annealing apparatus, which realizes a laser annealing method according to the invention, will be described in detail below with reference to the drawings.

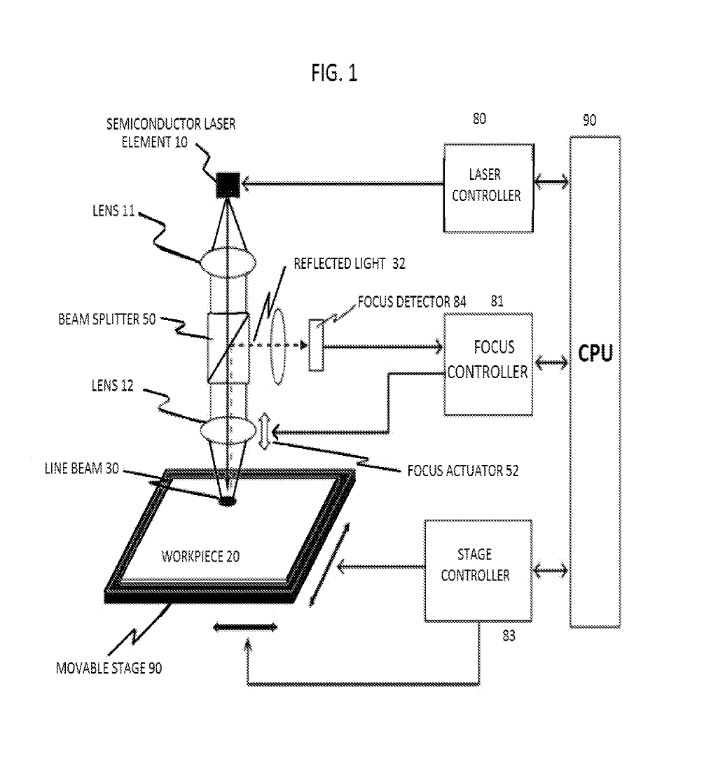

As illustrated in FIG. 1, a laser annealing apparatus according to this embodiment includes a semiconductor laser element 10, a lens 11, a beam splitter 50, an objective lens 12, a movable stage 90, a laser controller 80, a focus detector 84, an auto-focus controller 81, a stage controller 83, and a central processing unit (CPU) 100. The semiconductor laser element 10 generates laser light having a wavelength of about 405 nm. The lens 11 polarizes the laser light, which is generated from the semiconductor laser element 10, to collimated light. Laser light emitted from the lens 11 passes through the beam splitter 50, and the beam splitter 50 polarizes reflected light to be described below at an angle of 90° and emits the polarized light. The objective lens 12 has a high numerical aperture, and irradiates a workpiece 20, which is an object to be heated, with a line-shaped line beam 30 that is formed by the concentration of the laser light emitted from the beam splitter 50. The workpiece 20 is mounted on the movable stage 90, and the movable stage 90 moves the workpiece 20 in an X direction and a Y direction at a speed in the range of 10 mm/s to 1000 mm/s. The laser controller 80 controls the laser emission and laser power of the semiconductor laser element 10. The focus detector 84 detects reflected laser light, which is formed by polarizing light reflected from the workpiece 20 at an angle of 90° and emitting the polarized light by the beam splitter 50, and converts the reflected laser light into an electrical signal. The auto-focus controller 81 controls the focusing of the line beam 30 on the basis of the electrical signal that is converted by the focus detector 84. The stage controller 83 controls the movement of the movable stage 90 in the X direction and the Y direction. The CPU 100 controls the laser controller 80, the auto-focus controller 81, and the stage controller 83. Meanwhile, the wavelength of laser light, which can be absorbed well by metal, is selected as the wavelength of semiconductor laser of this embodiment. Accordingly, for example, Cu, Ag, and Au absorb the wavelength of laser light better as the wavelength of the laser light is lower, and the laser annealing apparatus uses laser light having a wavelength of about 405 nm, and is adapted to change the grain size or bonding state of metal by heating.

The laser annealing apparatus, which is formed as described above, is adapted so that the CPU 100 irradiates the workpiece 20 with the laser light, which is emitted from the semiconductor laser element 10, while controlling the focusing of the long and narrow line beam 30 on the workpiece 20, and performs the laser annealing of metal at a predetermined position on the workpiece 20 by changing an irradiation position on the workpiece 20, which is irradiated with the line beam 30, through the movement of the movable stage 90.

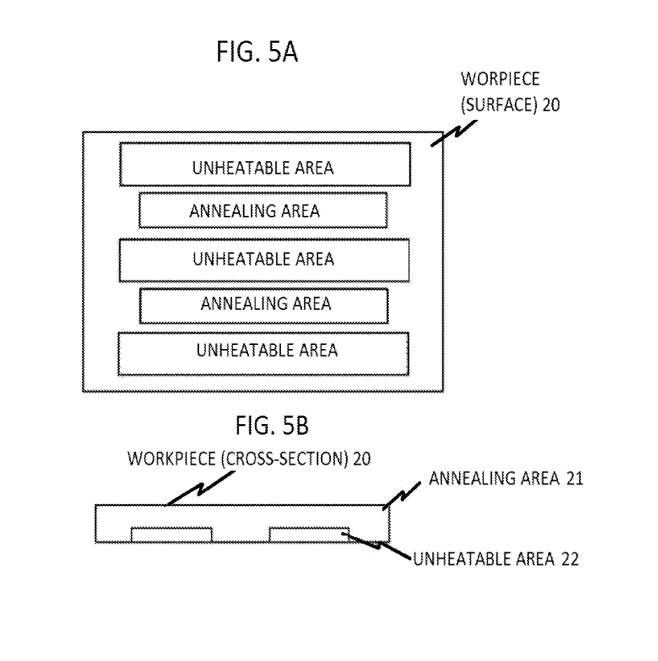

The workpiece 20, which is described in this embodiment, is, for example, an object which is to be heated and in which a semiconductor circuit element is formed on a workpiece or wiring is performed, annealing areas, which are objects to be heated, and unheatable areas, which should not be heated, are mixed as illustrated in FIG. 5A that illustrates the flat surface of the workpiece 20 and the unheatable areas are disposed at positions below the annealing areas, which are objects to be heated, in a width direction as illustrated in FIG. 5B that illustrates the cross-section.

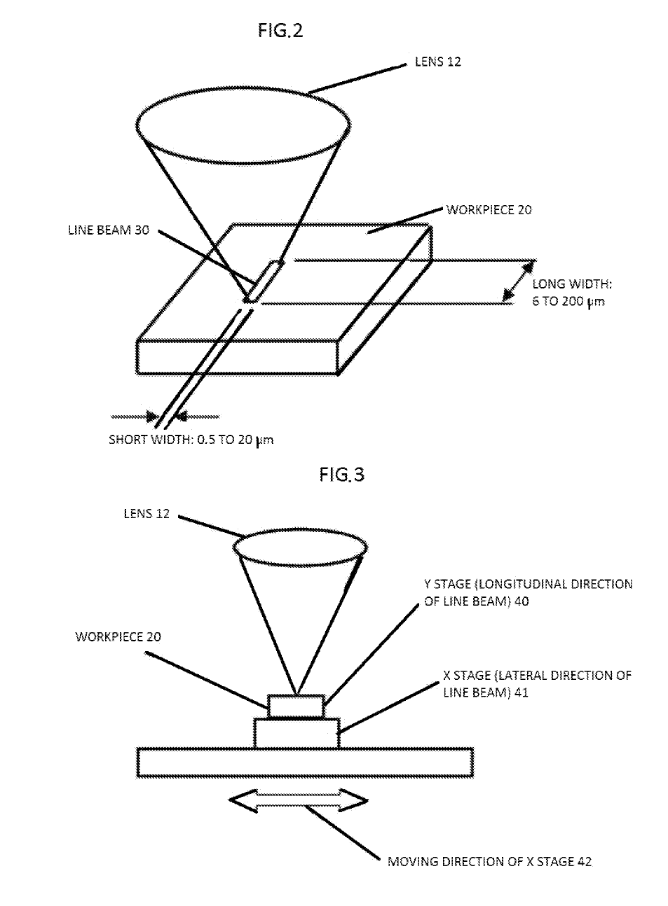

As illustrated in FIG. 2, the line beam 30, which is generated by the laser annealing apparatus according to this embodiment, has a depth of focus of several gm (about 2 μm to about 4 μm) on the workpiece 20 and has a long and narrow shape that has a width of about 0.5 μm to 20 μm in the short direction and a width of about 6 μm to 200 μm in the length direction and is formed by the objective lens 12. In particular, since the short width of the line beam 30 of this embodiment is small, the line beam 30 can locally raise the temperature of the workpiece in a thickness direction and can also suppress a temperature rise in a longitudinal direction if having a length in the range of about 6 μm to 200 μm in a longitudinal direction.

As illustrated in FIG. 3, the movable stage 90 includes a Y stage 40 on which the workpiece 20 is mounted and which moves only in the direction of a straight line Y, and an X stage 41 on which the Y stage 40 is mounted and which moves only in the direction of a straight line X orthogonal to the direction of the straight line Y. The movable stage 90 is adapted to be capable of moving the mounted workpiece 20 in an X-Y plane by the control of the stage controller 83 while a feeding speed is variable in the range of 10 mm/s to 1000 mm/s.

The focusing control of the laser annealing apparatus is performed by performing: a step of polarizing the laser light, which is generated from the semiconductor laser element 10 illustrated in FIG. 1, to collimated light and emitting the polarized laser light by the lens 11; a step of forming the line beam 30 having the above-mentioned shape and irradiating the workpiece 20 with the line beam 30 by the objective lens 12 that has received the emitted and collimated laser light through the beam splitter 50; a step of polarizing reflected light 32, which is reflected by the irradiation of the workpiece 20, at an angle of 90° by the beam splitter 50 and inputting the polarized reflected light to the focus detector 84; a step of converting the reflected light 32 into an electrical signal (focus signal) and inputting the electrical signal to the auto-focus controller 81 by the focus detector 84 to which the reflected light 32 has been input; and a step of performing auto-focus control so that the line beam 30 is focused on the workpiece 20 on the basis of the input electrical signal (focus signal) by the auto-focus controller 81.

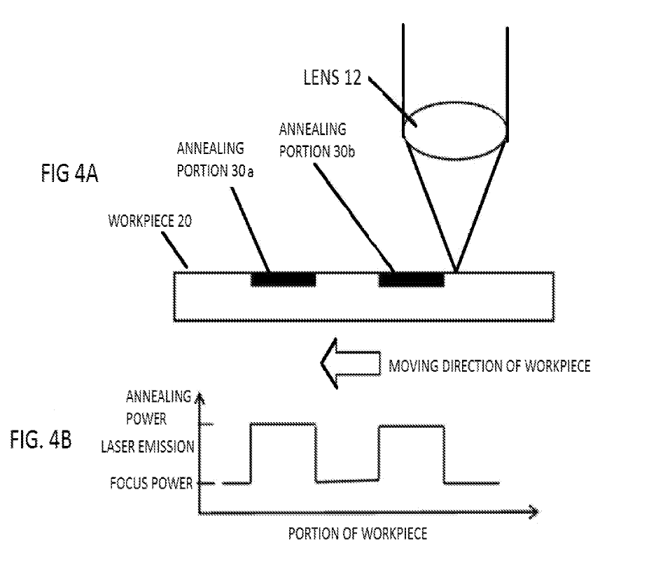

Further, the laser annealing apparatus can switch power to annealing laser power where the workpiece 20 is heated by the line beam 30 focused on the workpiece 20 and focus laser power where the workpiece 20 is not heated by the line beam. For example, as illustrated in FIGS. 4A and 4B, the workpiece is moved in the direction of an arrow of FIG. 4A after auto-focusing is performed on the surface of the workpiece 20 with the focus laser power. Then, power is switched to annealing laser power at the positions of annealing portions 30a and 30b, so that laser annealing can be performed only at an arbitrary portion with laser light having a depth of focus of several μm (about 2 μm to about 4 μm) while the auto-focusing is performed on the surface of the workpiece.

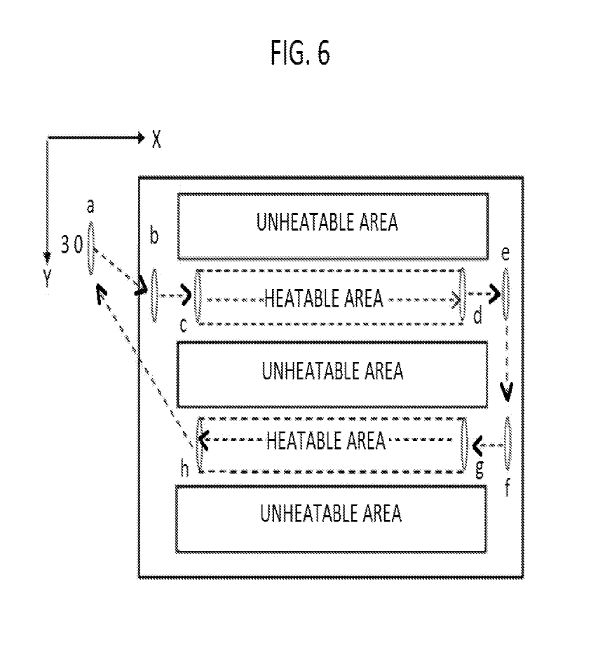

When unheatable areas and unheatable areas are alternately disposed in the longitudinal direction of the workpiece 20, a portion of the heatable area corresponding to a depth of focus of several μm (about 2 μm to about 4 μm) can be subjected to laser annealing at the arbitrary portion by performing: a first step of changing the position of the workpiece 20 relative to the position of the line beam 30 by the operation of the movable stage 90 as illustrated in FIG. 6 and turning off laser after adjusting annealing power (laser current) by the laser controller 80 when, for example, the lens 30 is positioned at a retreat position of a position “a”; a second step of moving the stage controller 83 to a focus position (an annealing-unnecessary area on the workpiece 20) from the position “a” in the X direction and the Y direction and temporarily stopping the stage controller 83 at a position “b”; a third step of turning on a focus servo at the position “b” with low power (focus power) where the laser controller 80 does not cause the change of the workpiece; a fourth step of accelerating the stage between a position “c” and the position “b” to an annealing speed in the X direction by the stage controller 83; a fifth step of switching power to annealing power and performing laser annealing with laser light having a depth of focus of several μm (about 2 μm to about 4 μm) between the position “c” (annealing start position) and a position “d” by the laser controller 80; a sixth step of switching power to focus power at an annealing end position of the position “d” by the laser controller 80; a seventh step of decelerating the stage between the position “d” and a position “e” in the X direction, temporarily stopping the stage in the unnecessary area on the workpiece, and moving the stage to a position “f” from the position “e” in the Y direction by the stage controller 83; an eighth step of accelerating the stage to an annealing speed (a relative moving speed that is determined by the combination with laser power and is required for heating) between the position “f” and a position “g” in the X direction by the stage controller 83; a ninth step of switching power to annealing power and performing laser annealing of the heatable area between the annealing start position of the position “g” and a position “h” by the laser controller 80; and a tenth step of turning off laser at the annealing end position of the position “h” by the laser controller 80 and moving the stage controller 83 to the retreat position of the position “a” in the X direction and the Y direction. Particularly, in this embodiment, the workpiece is moved between the position “b” and the position “c” and between the position “d” and the position “g” while the laser controller 80 irradiates the workpiece with the line beam 30 generated by the focus power. Accordingly, it is possible to prevent a portion of the workpiece 20, which corresponds to the irradiation position, from being heated.

As described above, in the laser annealing apparatus and the laser annealing method according to this embodiment, while the stage controller 83 moves the movable stage 90 in the X direction and the Y direction, the laser controller 80 forms a line beam at a focusing position on the workpiece in the heatable area on the workpiece 20 by an optical system, which has a long and narrow shape having a width of 0.5 μm to 20 μm in the short direction and a long width of 6 μm to 200 μm in the length direction and has a depth of focus in the range of 2 μm to 4 μm, and a heating step of performing laser annealing while controlling the focusing by the auto-focus controller and second laser power that has an output lower than the output of first laser power in the unheatable area on the workpiece 20 are selectively performed. Accordingly, a semiconductor circuit element in which circuit elements unsuitable for heating and circuit elements to be heated are mixed can also be heated locally (in a thickness direction, a circumferential direction, or the like).

What is claimed is:

1. A laser annealing apparatus that irradiates metal of a workpiece, on which heatable areas including metal disposed at arbitrary portions thereof and unheatable areas unsuitable for heating are disposed, with a long and narrow shape line beam to heat the metal and changes the grain size or bonding state of the metal, the laser annealing apparatus comprising:
a semiconductor laser element that generates laser light having a wavelength with high absorptance to metal;
a lens that polarizes the laser light, which is generated from the semiconductor laser element, to collimated light;
a beam splitter through which laser light emitted from the lens passes and which polarizes reflected light at an angle of 90° and emits the polarized light;
an objective lens that has a high numerical aperture, and irradiates the workpiece with a line-shaped line beam that is formed by the concentration of the laser light emitted from the beam splitter;
a movable stage on which the workpiece is mounted and which moves the workpiece in an X direction and a Y direction on a plane at an arbitrary speed;
a laser controller that controls the laser emission of the semiconductor laser element;
a focus detector that detects light reflected from the workpiece by the beam splitter and converts the reflected light into an electrical signal;
an auto-focus controller that controls the focusing of the line beam on the basis of the electrical signal converted by the focus detector;
a stage controller that controls the movement of the movable stage in the X direction and the Y direction; and
a control means for controlling the laser controller, the auto-focus controller, and the stage controller,
wherein while the stage controller moves the movable stage in the X direction and the Y direction, the laser controller forms a line beam at a focusing position on the workpiece in the heatable area on the workpiece by an optical system, which has a long and narrow shape having a width of 0.5 μm to 20 μm in the short direction and a long width of 6 μm to 200 μm in the length direction and has a depth of focus in the range of 2 μm to 4 μm, and
a heating step of performing laser annealing while controlling the focusing by the auto-focus controller and second laser power that has an output lower than the output of the first laser power in the unheatable area on the workpiece are selectively performed by the laser controller.
